(19) United States
(12) Patent Application Publication
(10) Pub. No.: US 2023/0350449 A1
(43) Pub. Date: Nov. 2, 2023

(54) Mesostructural Reset Unit

(71) Applicant: elobau GmbH & Co. KG, Leutkirch (DE)

(72) Inventors: Michael REISCH, Leutkirch (DE); Manfred SÜSSMANN, Elchingen (DE)

(21) Appl. No.: 18/140,255

(22) Filed: Apr. 27, 2023

(30) Foreign Application Priority Data
May 2, 2022 (DE) 10 2022 110 703.5

(51) Int. Cl. G05G 5/05; F16F 3/087

(52) U.S. Cl. CPC G05G 5/05; F16F 3/0876

(57) ABSTRACT

A reset unit for resetting rotational and/or translational deflection movements of a setting element is provided. The reset unit has an ordered mesostructure of elementary cells consisting of an ordered arrangement of at least two elementary cells, wherein the at least two elementary cells each have at least one pore, which allows the elementary cells to be reversibly compressed and expanded through exposure to force, wherein a reset force of the reset unit can be at least partially generated by deforming the mesostructure.

This U.S. Pat. Application claims priority to German patent application no. DE 10 2022 110 703.5, filed May 2, 2022, the entire contents of which is incorporated herein by reference in its entirety.

### BACKGROUND

### 1. Technical Field

The present invention relates to a mesostructural reset unit, in particular for application in operating devices of construction machines, agricultural tractors and other commercial vehicles.

### 2. Related Art

Such operating devices are used among other things for controlling commercial vehicles, machines, working functions of commercial vehicles or construction machines and attachments. Within the meaning of the invention, operating devices are any devices that have control elements, for example such as travel levers, travel pedals, keys and in particular joysticks. For example, armrests that have a plurality of control elements are operating devices according to the invention. As sufficiently known for such control elements, they have reset units which move the control element from a deflected position back into its starting position through exposure to a reset force.

In prior art, these reset units are regularly elastic elements, such as springs or elastomers, but also electrical elements such as actuators, for which a force curve can also be changed after installation without replacing the installed parts, unlike the elastic elements. By contrast, the elastic elements would have to be removed from the control elements and replaced by new ones having the desired elasticity. Alternatively known as well are adaptive elastic materials, meaning whose material properties, such as elasticity, can be changed by applying a current or magnetic field. The disadvantage to all of these known reset units is that they are not adaptable, just like the elastic elements, so that a commitment must be made during production to a line of force to be determined in the future that can only be changed through a redesign, or that, just as the electrical elements, they are especially space-and material intensive, and require a plurality of different materials. Along with this, it is disadvantageous with respect to such elements that, as a rule, the maintenance of individual parts of these electrical elements is cost and time intensive. While one solution to the above in prior art involves the modular configuration of the reset units, the latter also do not resolve the problem of the resource-intensive configuration.

While the elastic materials mentioned at the outset are relatively resource-efficient as opposed to the adaptive elements, they regularly lack adaptivity. In prior art, this problem is regularly resolved by enhancing these elastic materials with an adapting module. For example, an actuator is regularly placed in front of the spring, which can preload the spring as needed, and thereby change the reset force. However, this configuration also has the disadvantage that the originally resource-efficient configuration of the elastic reset unit is likewise resource-intensive due to the adapting module, and in particular increases the costs and space requirement of the reset unit.

### SUMMARY

The object of the invention is to indicate a reset unit that is especially resource-efficient and adaptively expandible.

In order to achieve this object, the invention provides among other things for the use of a mesostructure. Mesostructures in prior art are per se generally known as structures having a porosity. This porosity can be a stochastic porosity, for example as in sponges or foams, but also an ordered porosity, for example a honeycomb structure. An ordered porosity leads to a structure consisting of individual elementary cells, the behavior of which during compression or decompression is defined based upon the properties of the elementary cells. Likewise conceivable is an ordered mesostructure with different, combined elementary cells, for example which vary in their shape or material properties. As a result, the behavior of the structure is likewise determined by the arrangement and alignment of these different types of elementary cells.

The design of the mesostructure is configured so that the material yields in a defined manner, thereby enabling one or several defined degrees of freedom. To this end, the mesostructure is designed in such a way that parts of the volume structure or the material orientation at least partially do not follow the direction of force. This leads to movement, or to a yielding of the structure. As a consequence, the force flow can be guided in an optimized manner by configuring the mesostructure out of a combination of several elementary cells. Depending on the material, such mesostructures are also especially easy to manufacture, for example using an additive method like 3D printing.

The mentioned object is achieved by a reset unit for resetting rotational and/or translational deflection movements, which has an ordered mesostructure of elementary cells consisting of an ordered arrangement of at least two elementary cells, wherein the at least two elementary cells each have at least one pore, which allows the elementary cells to be reversibly compressed and expanded through exposure to force, wherein a reset force of the reset unit can be at least partially generated by deforming the mesostructure.

According to the invention, the reset unit can be used in a setting element, which in the sense of the invention in particular can be a control lever or another control element, although the reset unit is also suitable for use with other contact surfaces, which for example are to have a force-feedback function. The reset unit has an ordered, but not stochastic mesostructure. This mesostructure is formed out of at least two elementary cells, which are configured, arranged, and connected depending on the intended force effect. Each elementary cell is here initially characterized by the fact that their shape connects two points in space via an indirect path. One elementary cell always has a curvature or edge. Furthermore, each elementary cell has at least one pore in the sense of the invention. In the sense of the invention, a pore is here a recess, which is enclosed in at least one plane, meaning that any starting point on the framework of the elementary cell can be found again as an end point by completely running the frame. For example, a ring or some other framework with a hole is an elementary cell with a pore in the sense of the invention. Even a framework shaped like an eight with two holes is an elementary cell in the sense of the invention, but has two pores. By contrast, for example, a coil of a spring is not an elementary cell in the sense of the invention, since even though it does have a recess, one end of the coil as the starting point cannot be reached again by running the entire coil. In addition, the material forming the mesostructure is a flexible material. Based upon this configuration and the material composition of the elementary cells, the latter can be reversibly compressed and expanded during an application of force. The application of force that leads to the compression or expansion of the elementary cells can here be point or area, a translational or rotational force. The direction of force is not necessarily limited to the aforementioned plane of the pores or elementary cell. Due to the application of force on the reset unit, a force acts on the mesostructure, and hence on at least one elementary cell, which is deformed as described. As a result, all elementary cells connected with this deformed elementary cell are also deformed. In addition, this deforms the mesostructure as a whole. Due to the reversibility of the compression and expansion of the elementary cells and their linear-elastic material behavior, they generate the reset force that resets the mesostructure in its resting position. The specific arrangement of the elementary cells and configuration of their degrees of freedom generate a defined spatial spring effect of the reset unit.

A further development of the invention provides that the reset unit have at least two mesostructures, in particular identical mesostructures, which are connected in parallel in terms of force application. In the sense of the invention, the parallel connection of the mesostructures is to be understood as an arrangement of the latter one next to the other, so that the arrangement of mesostructures is perpendicular to the direction of force application. If the mesostructures are here identical, meaning are the same with respect to their structure, shape, material, and arrangement, it is irrelevant in terms of the invention if individual mesostructures were to drop out, for example due to fatigue and breakage of the material, since the remaining functional mesostructures can continue generating the reset force. This advantage of mechanical redundancy is strengthened as the number of applied mesostructures increases. Likewise in keeping with the invention, the reset unit has at least two mesostructures, in particular identical mesostructures, which are connected in series to each other in terms of force application, meaning the arrangement of mesostructures is aligned in the direction of force application. As a whole, the reset unit is in this way subjected to less of a load, if the load from a mesostructure that dropped out is distributed among as many remaining functional mesostructures as possible. This advantageous load distribution can otherwise also arise within a mesostructure if it has an especially high number of elementary cells connected in series and/or in parallel, for example in the form of a grid, in which an elementary cell could drop out, while the load originally handled by this elementary cell is distributed among the remaining, undamaged elementary cells. Also conceivable is a parallel connection of nonidentical mesostructures. This makes it possible to achieve a specific reset force distribution via the reset unit, for example in the form of overprint points, which are generated by arranging rigid mesostructures between otherwise less rigid mesostructures.

One configuration of the invention provides that an elastic element, in particular a spring or an elastomer, or an adaptive element, in particular an actuator or an MRF element, be placed upstream and/or downstream from at least one elementary cell in terms of force application. In the sense of the invention, the upstream or downstream placement is to be understood as a series connection, in which the elementary cell and the elastic or adaptive element are arranged parallel to each other relative to the direction of force application. The elastic element is here understood to be a purely passive element, which upon deformation generates its own predefined reset force, which overlays the reset force of the upstream or downstream elementary cell. The adaptive element is understood to be active elements, which can be operated by a user. In this way, a user can actuate the adaptive element to set the reset force thereby generated or the preload of the upstream or downstream elementary cell as needed. An MRF element is here an element having a magnetorheological fluid, whose viscosity can be influenced by a magnetic field. These elements make it possible to generate a preload at specific locations within a mesostructure. This enables additional options for setting a force line suitable for the application. In particular adaptive elements make it possible to switch on a preload or a final damping, if needed. As a consequence, the force line of the reset unit can also be adjusted to a needs-based linear or nonlinear force line. Otherwise, such a series connection of elastic and/or adaptive elements with at least one mesostructure is also proposed according to the invention, so that the preload also acts on an entire mesostructure. The latter can be combined with the series connection of the elementary cells and elastic and/or adaptive elements arranged in the aforementioned mesostructure, so as to be able to define an especially detailed force line distribution over the entire reset unit.

A further development of the invention provides that at least one mesostructure have at least two different elementary cells, which vary with respect to their structure, shape, material and/or arrangement. According to the invention, the mesostructure can also have portions of a stochastic mesostructure enhanced by elementary cells according to an ordered mesostructure. By selecting the structure and shape of the elementary cells, the force line of the reset unit can be influenced, for example depending on the compression or tensile force. Different materials according to the invention in particular include those materials that can be produced via an additive manufacturing process, for example via 3D printing, so as to make production especially easy. Likewise advantageous are electrically conductive or magnetic materials, whose stiffness can be influenced by an external magnetic or electric field. In this way, individual elementary cells can be preloaded when applying a magnetic or electric field, and the force line of the reset unit can thereby be influenced. However, basically any reversibly flexible materials fit the invention. In particular, the arrangement of elementary cells can differ with respect to their orientation relative to each other. Different force reactions in different spatial directions can be generated by combining such different elementary cells. These different force reactions can be linear and nonlinear forces, which can be combined into force lines suitable for the application. In addition, this makes it possible to achieve an elevated stability against the various forces in different spatial directions. The high number of combinable materials, structures, shapes, and applications yields a nigh number of possible embodiments of the reset unit according to the invention, and hence a high variability of application.

An embodiment of the invention provides that the reset unit have different mesostructures, which are interchangeable in use. This interchangeability is advantageous in particular for such mesostructures that differ with respect to their structure, shape, material and/or arrangement. Changing out the mesostructures makes it possible to switch between different, predefined force lines, which as already described above arise from the respective constitution of the selected mesostructure. This enables a needs-based activation of a specific mesostructure, whose force line corresponds to the current application. In particular in applications where different environmental factors or usage types arise, an individual reset unit can be optimally adjusted for the most varied of requirements. For example, the reset unit can be used in an operating device of an agricultural machine like a tractor, to which the most varied of working machines with different functions are coupled. These are usually controlled via a constant central controller in the tractor. However, the reset unit according to the invention can be used to always adjust the control device to the connected working device, at least in terms of the reset force lines.

A further development of the invention provides that the different mesostructures be interchangeable with each other in the reset unit by means of a changing magazine, in particular a drum changing magazine. This yields the advantages to the different interchangeable mesostructures described above. In the sense of the invention, a changing magazine is a device in which several different mesostructures are accommodated separately from each other and retrievable. For example, this can be a linearly displaceably mounted magazine, whose displacement makes it possible to retrieve different mesostructure segments. However, an especially advantageous drum changing magazine is one that constitutes an especially simple embodiment of a changing magazine, in which the mesostructure to be used is turned into an active position, while the remaining mesostructures are not effectively connected with an element to be reset, for example an operating device. In addition, a drum changing magazine can be designed in an especially space-saving manner. The application of such a changing magazine enables a modular configuration of the reset unit, in which individual mesostructures can be exchanged, for example during maintenance or given modified requirements on the reset unit. Accordingly, it is especially advantageous that the different mesostructures be insertable into the changing magazine in a detachably connectable manner.

An embodiment of the invention provides that at least one mesostructure have at least one signal generator. A signal generator is understood as an element that is integrated or attached in the mesostructure, which emits a signal that is perceptible outside of the reset unit by a signal receiver, and thereby ensures that the positions or parameters of the structure can be determined with respect to expansion, material parameters or similar parameters. For example, such a signal generator can be a simple magnet, which emits a signal perceptible from outside of the reaction unit by sending out a magnetic field. Likewise in keeping with the invention is a passive signal generator, for example in which a light coming from outside of the mesostructure is varyingly refracted or covered depending on the deformation of the mesostructure, and this influenced light is perceptible from outside of the mesostructure. Likewise in keeping with the invention is the use of signal generators that form a part of the mesostructure or individual elementary cells, i.e., are molded or integrated therein. Furthermore, the invention provides that the reset unit can additionally or exclusively have a reaction unit and/or an evaluation unit. The reaction unit must be understood as an element that reacts to an external action, for example to a magnetic or an electric field, with a corresponding change in at least one property, such as the position, orientation, or stiffness. The reaction unit is here arranged in or on the mesostructure or an elementary cell in such a way that the change in the property of the reaction unit leads to an altered force line of the reset unit. In this way, the reaction unit, just as the signal generator, can be a component of the mesostructure or elementary cell, or only be arranged thereon. The invention also proposes both a passive reaction unit, such as a magnet, and an active reaction unit, which can only be switched on if required and/or whose reactivity is modifiable. For example, an active reaction unit is an electromagnet, which depending on the applied current changes its magnetic field, which reacts to an external magnetic field. In the sense of the invention, the evaluation unit is an element that receives the change in the aforementioned parameters of the signal generator. An evaluation in terms of a utilization or interpretation of the received signals is here not mandatory. A detection of a change is thus sufficient in itself. Alternatively or additionally, the evaluation unit according to the invention is an element that actuates the reaction unit, and thereby triggers the desired reactions of the latter as required.

Further proposed according to the invention is an operating device having a reset unit as described above. In particular those operating devices which usually have a reset unit can be variably used as needed through the application of the reset unit according to the invention described above. This is especially advantageous in particular with respect to joysticks and other control levers, but also with respect to control keys and touchpads. Operating devices whose operating motion involves a rotational movement can also have the reset unit according to the invention. It is here especially advantageous that the operating device be effectively connected with the reset unit in such a way that the movement of the operating devices produces a compression or expansion of the reset unit, so that the latter triggers a reset force on the operating device. In addition, a rotational force acting on the mesostructures provided in the reset unit can also be offset by the mesostructures given the corresponding properties.

A configuration of the operating device according to the invention provides that it have a control lever, wherein the reset unit is mounted in the control lever, in particular in an element of the control lever that scans a motion link. The configuration of the reset unit and the shape of the motion link can here form a needs-based force line, by way of which the control lever sends out feedback to a user that varies depending on position or deflection. This force line can here be modified not just by the motion link selected. Rather, the design flexibility is especially great based upon the possible high complexity of the mesostructure. In addition, the reset unit is especially low maintenance due to the redundancy of the elementary cells.

A further development of the operating device according to the invention provides that it have a motion link into which a control lever is guided, wherein the reset unit resets the motion link. With regard to the embodiment of the invention described above, in which the reset unit is mounted in the control lever, the force line of the reset force can also be adjusted in this embodiment by the shape of the motion link or the configuration of the reset unit. Depending on the shape of the motion link, the motion link is here forced away from the element that scans the motion link at a specific deflection of the control lever, and the reset unit is tensioned accordingly. The reset force generated by the reset unit forces the motion link, and hence also the control lever guided in the motion link, into its starting position. One especially simple arrangement of the reset force involves an arrangement on the motion link on the side of the motion link lying opposite the control lever. In addition, it is especially advantageous that the motion link have a flexible design, i.e., that it can be forced away by the control lever and reset by the reset unit not just in its entirety. In this way, the great design flexibility of the reset unit makes it possible to provide individual sections of the motion link with varying stiffnesses of the reset unit. This effect can be reinforced again with volume bodies on the motion link, in particular those having a stiffness that differs from the remainder of the motion link. In this way, selecting the suitable motion link shape and the configuration of the reset force makes it possible to generate a needs-based force line, and thereby create an overpressure point.

A configuration of the operating device according to the invention provides that the motion link consist of multiple parts, wherein at least one of these motion link parts is reset by a reset unit. In such an embodiment, the control lever itself need not be reset by a reset unit. Rather, at least one of the motion link parts is reset by the reset unit here as well. This can be realized in the form of a motion link system, in which the at least one motion link part comprises a motion link for the control lever guided in the latter, wherein the motion link subjects the control lever to a reset force altered depending on its position. The invention likewise provides that individual sections of a motion link, which are only contacted by the control lever guided therein during specific deflections thereof, be provided with reset units or reset units differing from the remaining motion link parts, so that a needs-based reset behavior of the reset unit can be achieved depending on the control lever deflection. This makes it possible to again generate more specific force lines of the reset unit and an especially individual motion link system, for example with overprint points.

A further development of the operating device according to the invention provides that it have a contact surface contacted by a user, which is reset by the reset unit. By applying the reset unit according to the invention in such contact surfaces, the haptics of the contact surface can advantageously be defined depending on the properties of the reset unit and the mesostructures used therein. These adjustable haptics make it possible to variably adjust the contact surface to a user who is contacting it. In addition, a segmentation of the reset unit allows the haptics to be locally limited and especially precisely adjusted to the user, or to deliver information about the contact surface to the latter. If the contact surface is a support surface, for example an arm support surface of an armrest, the latter can be equipped with the reset unit over its entire surface. In this case, the support surface yields ergonomically according to the contact of the user, depending on the stress and stress position. Here as well, the stiffness can be defined by the structure, shape, material, and arrangement of the mesostructures and elementary cells of the reset unit. A spatially variable stiffness can also be defined by the reset unit according to the invention. By contrast, a variable stiffness could only be achieved with a high design effort when using conventional upholstery. In the case of a contact surface in the form of a control surface, for example a touchpad, the haptics of the contact surface can likewise be defined through the needs-based and suitable selection of the structure, shape, material, and arrangement of the mesostructures and elementary cells of the reset unit [the stiffness of the contact surface]. A handle of the control lever, i.e., the part [word missing] to a user and contacted by the latter during use, is likewise proposed as the contact surface according to the invention, in which using the reset unit offers the same advantages already mentioned. This provides the user with both a specific haptic and a visual feedback resulting from the change in shape of the contact surface. Based upon the configuration of elementary cells and the mesostructure formed from the latter, the structure also makes it possible to detect the light of a display shown behind it. The light behind the structure can shine through it, or also be routed through light guides integrated into the structure of the reset unit, and thereby shown to a user in front of the reset unit.

### BRIEF DESCRIPTION OF THE DRAWINGS

In a preferred embodiment, the invention will be exemplarily described with reference to a drawing, wherein several advantageous details may be gleaned from the figures of the drawing.

Functionally identical parts are here provided with the same reference numbers.

Specifically shown on the figures of the drawing are:

FIG. 1: an exemplary mesostructure in the sense of the invention,

FIG. 2a: a first alternative of a reset unit according to the invention during application with an operating device in an idle state,

FIG. 2b: a first alternative of a reset unit according to the invention during application with an operating device in a deflected state,

FIG. 3: a second alternative of a reset unit according to the invention during application with an operating device in an idle state,

FIG. 4a: a third alternative of a reset unit according to the invention during application with an operating device in an idle state,

FIG. 4b: a fourth alternative of a reset unit according to the invention during application with an operating device in an idle state,

FIG. 5a: a first alternative of a reset unit according to the invention during application with a flexible motion link,

FIG. 5b: a second alternative of a reset unit according to the invention during application with a flexible motion link,

FIG. 5c: a third alternative of a reset unit according to the invention during application with a flexible motion link,

FIG. 6: a changing magazine according to the invention with different mesostructures,

FIG. 7: a reset unit according to the invention during application in the handle of a control lever.

### DETAILED DESCRIPTION OF EXAMPLE EMBODIMENTS

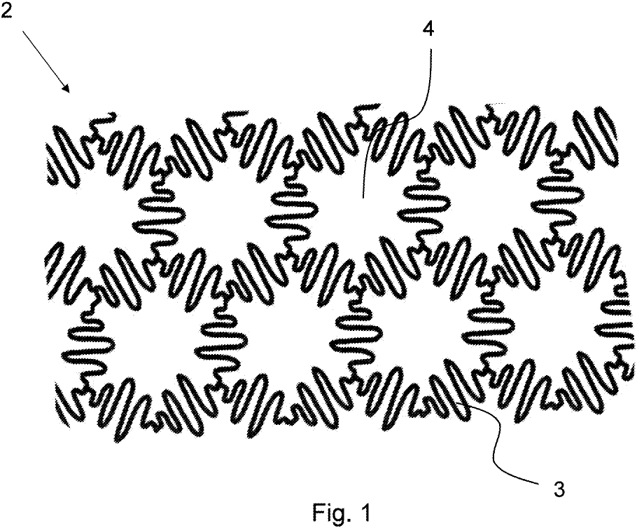

FIG. 1 shows an exemplary mesostructure 2 in the sense of the invention. The depicted mesostructure 2 is an ordered, i.e., non-stochastic, mesostructure 2, which has several elementary cells 3. In the exemplary embodiment shown, the elementary cells 3 are comprised of several undulating walls, which are arranged in such a way relative to each other as to form roughly a hexagon in one plane, in the middle of which a recess is arranged as a pore 4. The formation of a hexagon in one plane is here to be construed to mean that a point on the wall of the elementary cells 3 can again be reached by running the elementary cell 3. The pore 4 is hence a recess that is enclosed by the elementary cell 3 at least on the plane upon which the elementary cell 3 forms essentially a hexagon. Due to the shape of the elementary cells 3 and their flexible material, the elementary cells 3 can be reversibly compressed and expanded during exposure to a force. The entire mesostructure 2 can thus be reversibly compressed and expanded, both locally over individual elementary cells 3, and overall over all elementary cells 3 taken together. This enables a precise, needs-based application of the mesostructure 2, but also a high variability in design of this mesostructure 2, which can be adjusted through the suitable selection of elementary cells 3 and their structure, arrangement, shape and/or material, and through their arrangement relative to each other individually or as a whole, depending on the application. The redundancy of the elementary cells 3 makes it possible to compensate for the failure of individual elementary cells 3 by redistributing the forces to the remaining elementary cells 3. This ensures the continued overall function of the reset unit 1, even given a failure of individual elementary cells 3.

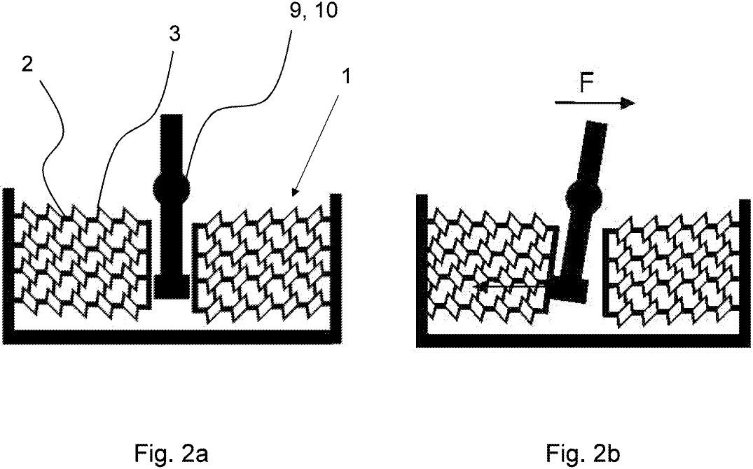

FIG. 2a shows a first alternative of a reset unit 1 according to the invention during use with an operating devices 9 in an idle state. The reset unit 1 is comprised of a mesostructure 2 having several elementary cells 3. The depicted configuration of the mesostructure 2 is to be understood as an example of one of numerous possible configurations of the mesostructure 2, which can assume a wide variety of forms, as already explained with regard to FIG. 1. While the operating device 9 is a control lever 10 in the embodiment shown, any other rotatable or swiveling operating device 9 can be used with the depicted embodiment of the reset unit. In the embodiment shown on FIG. 2a, the reset unit 1 is arranged in the swiveling direction toward the end of the operating device 9 facing away from the user. During the deflection of the operating device 9 and, as illustrated by the direction of force marked on FIG. 2b, the accompanying compression of the reset unit 1, the reset force of the reset unit 1 thus acts opposite the swiveling direction of the operating device 9 without any further force redirection. FIG. 2b shows the same reset unit 1 according to the invention during application with an operating device 9 in a deflected state. During the deflection, an end of the operating device 9 guided in the reset unit 1 is swiveled, and presses against the reset unit 1 in such a way as to compress it. As a result, a reset force is generated in the mesostructure 2, which resets the reset unit 1 in its idle state, and thereby counteracts the operating device 9 and its deflection.

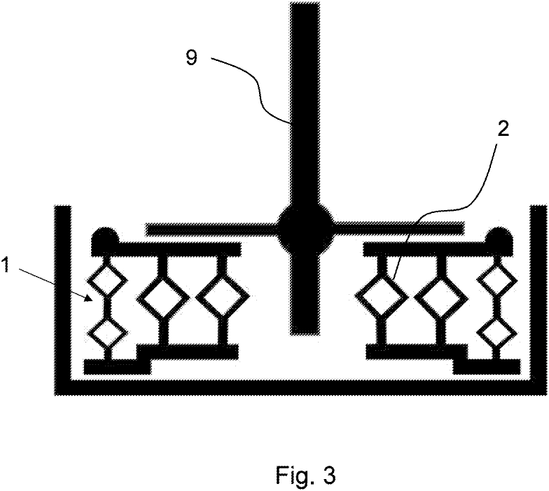

FIG. 3 shows a second alternative of a reset unit 1 according to the invention during application with an operating device 9 in an idle state. The reset unit 1 is shown during application with an operating device 9, wherein the operating device 9 has an arm or a plane perpendicular to the longitudinal axis of the operating device 9, which when the operating device 9 is deflected comes into contact with the reset unit 1, and compresses it. The reset force generated in the reset unit 1 resets the operating device 9 into its idle position. The reset unit 1 has several mesostructures 2 connected in parallel to each other, which here are depicted as schematic squares. This schematic illustration comprises any forms of mesostructures 2 which according to the invention each have at least two elementary cells, each with at least one pore. The parallel connection of the mesostructures 2 is to be understood as an arrangement of the latter one next to the other, so that the arrangement of the mesostructures 2 is arranged perpendicular to the direction of force application. This redundancy of the parallel connected mesostructures 2 can compensate for the failure of individual mesostructures 2 by redistributing the forces to the remaining mesostructures 2. As a result, the function of the reset unit 1 remains completely intact even given the failure of individual mesostructures 2. By serially connecting mesostructures 2 at selected locations, i.e., by arranging the mesostructures 2 in a direction of force application relative to each other, force lines that differ from the remaining mesostructures 2 can be generated at these locations, for example so as to form overprint points. By suitably selecting serial and parallel connections for the mesostructures in specific positions, a specific, needs-based force line of the reset unit 1 can be achieved in this way.

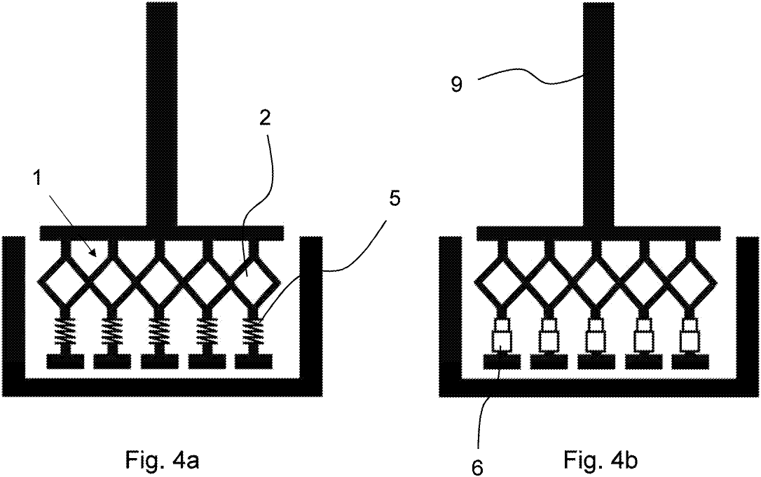

FIG. 4a shows a third alternative of a reset unit 1 according to the invention during application with an operating device 9 in an idle state. In this embodiment, the operating device 9 transmits both swiveling movements as well as tensile and compressive movements to the reset unit 1, as a result of which the reset unit and the flexible elements contained therein are compressed and expanded accordingly. In this embodiment, the reset unit 1 has a plurality of mesostructures 2 connected in parallel to each other, which offer the advantages already mentioned. In the embodiment shown, the mesostructures 2 and elastic elements 5 are here connected to each other in series in the form of springs, i.e., arranged parallel to each other relative to the direction of force application. In the sense of the invention, the spring is a simple variant of an elastic element 5, which is a passive element that upon deformation generates a predefined reset force which overlays the reset force of the upstream or downstream mesostructure 2. By contrast, FIG. 4b shows a fourth alternative of a reset unit 1 according to the invention during application with an identical operating device 9 in an idle state, wherein the mesostructures 2 in this embodiment are connected in series with adaptive elements 6, here in the form of actuators. As opposed to the elastic elements on FIG. 4a, these are active elements that can be operated by a user. Therefore, by actuating the adaptive elements 6, a user can set the reset force thereby generated or the preload of the downstream mesostructure 2 as needed. Both the elastic and also the adaptive elements generate a preload on the downstream mesostructures 2. As a result, the reset unit 1, which is already variably configurable owing to the variability of the mesostructure 2, can once again be more flexibly used, and a force line can be determined in an especially precise manner.

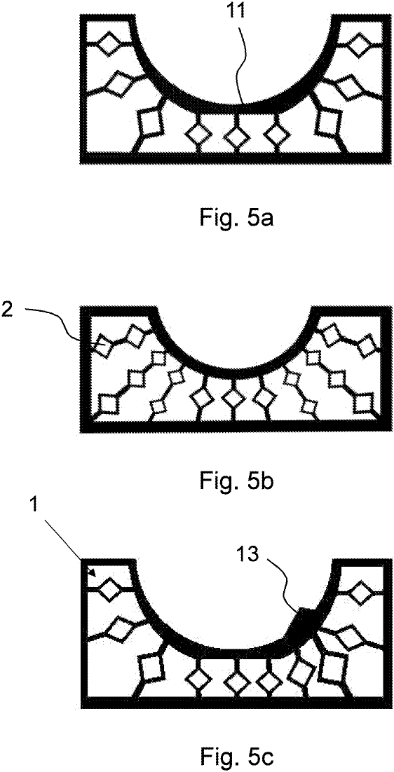

FIG. 5a shows a first alternative of a reset unit 1 according to the invention during application with a flexible motion link 11. In this application, an operating device that is movably, in particular swivelably, guided at one end in the motion link 11, and the motion link 11 are correspondingly deformed and/or displaced during a deflection of the operating device. Therefore, the depicted motion link 11 can be variable in its basic shape, which amounts to a deformation, or be mounted so that it can only be moved in its entirety, so that the entire motion link 11 is moved relative to a base during a displacement. The motion link 11 is here reset into its idle position by the reset unit 1 effectively connected with it. Here as well, the reset unit 1 has several parallel connected mesostructures 2, which each reset individual areas of the motion link 11 and the motion link 11 in different directions of force based upon their orientation. By contrast, FIG. 5b shows a second alternative of a reset unit 1 according to the invention during application with a flexible motion link 11, in which mesostructures 2 are connected in series to each other at selected locations. This yields other force lines, by means of which the reset force is varyingly adjusted depending on the position of the operating device in the motion link 11 independently of the actual motion link shape. As a result, for example, overprint points or other needs-based specific force lines or points can be generated. Contrary to the above,

FIG. 5c shows a third alternative of a reset unit 1 according to the invention during application with a flexible motion link 11, in which such an overprint point is generated by combining the springy mesostructures 2 and above all a volume body on the motion link, which can have a stiffness different than the motion link. Here as well, the stiffness of the volume body and the properties and arrangement of the mesostructures 2 make it possible to generate a needs-based force line in the area of the overprint point.

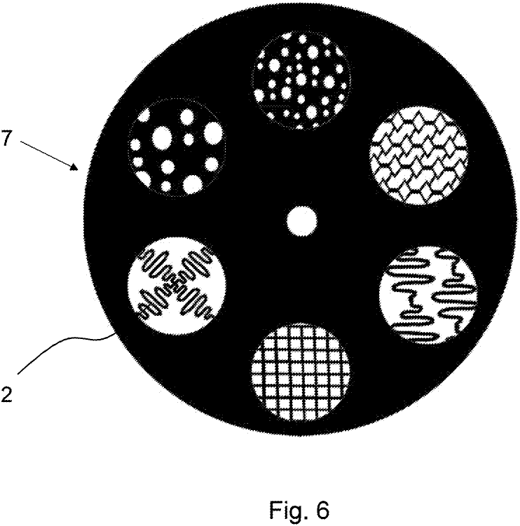

FIG. 6 shows a changing magazine 7 according to the invention with different mesostructures 2. The changing magazine 7 is here only shown schematically, and is intended to illustrate the basic function. Accordingly, the changing magazine 7 has several chambers, into which different mesostructures 2, here likewise only shown schematically, are in particular detachably inserted. The changing magazine 7 is arranged in such a way relative to an operating device as to be forcefully connected with one of the chambers of the changing magazine, so that a movement of the operating device results in a compression or expansion of the mesostructure 2 arranged in said chamber. If such a changing magazine configured as a drum changing magazine is rotatably mounted, then rotating it can move each of the mesostructures 2 arranged therein into a position forcefully connected with the operating device. Depending on the mesostructures 2 selected, highly specific force lines can be prepared as needed, which correspond to specific applications of the reset unit or the operating device to be reset. The chambers are not limited to a homogenous distribution of mesostructures 2 or elementary cells. Rather, individual chambers of the changing magazine 7 can have several chambers of mesostructures, of which only individual chambers are compressed or expanded, depending on the deflection of an operating device to be reset, as exemplarily shown on FIGS. 2a, 2b and 3. The invention also provides for a variation of mesostructures in such a way as to yield specific force lines, as depicted on FIGS. 3, 4a, 4b and 5b.

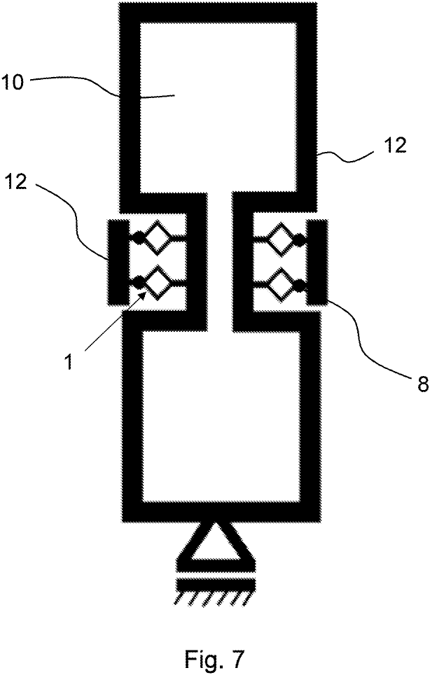

FIG. 7 shows a reset unit 1 according to the invention during application in the handle of a control lever 10. The handle of a control lever 10 is the end of the control lever 10 that is contacted by a user while in use. Accordingly, the surface of the handle is a contact surface 12 for the user. The reset unit 1 is here arranged in the handle in such a way that the user compresses the reset unit 1 while using the handle due to the contact. Therefore, the user perceives the reset force depending on the intensity of the compression. In addition, the reset unit 1 has signal generators 8, which emit a signal that is perceptible from outside. For example, the signal generators 8 can be simple magnets, which emit a magnetic field that can be perceived by a Hall sensor or other elements. As a result, a positional change of the signal generators 8 during compression or expansion of the reset unit 1 can be perceived and evaluated.

1. A reset unit for resetting rotational and/or translational deflection movements, which has at least one ordered mesostructure consisting of an ordered arrangement of at least two elementary cells, wherein the elementary cells each have at least one pore, which allows the elementary cells to be reversibly compressed and expanded through exposure to force, wherein a reset force of the reset unit can be at least partially generated by deforming the mesostructure.

2. The reset unit according to claim 1, wherein the reset unit has at least two mesostructures, in particular identical mesostructures, which are connected in parallel in terms of force application.

3. The reset unit according to claim 1, wherein an elastic element, in particular a spring or an elastomer, or an adaptive element, in particular an actuator or an MRF element, is placed upstream and/or downstream from at least one elementary cell in terms of force application.

4. The reset unit according to claim 1, wherein at least one mesostructure has at least two different elementary cells, which vary with respect to their structure, shape, material and/or arrangement.

5. The reset unit according to claim 1, wherein the reset unit has different mesostructures, which are interchangeable in use.

6. The reset unit according to claim 1, wherein the different mesostructures are interchangeable with each other by means of a changing magazine in the reset unit, in particular a drum changing magazine.

7. The reset unit according to claim 1, wherein at least one mesostructure has at least one signal generator.

8. An operating device having a reset unit according to claim 1.

9. The operating device according to claim 8, wherein the operating device has a control lever, wherein the reset unit is mounted in the control lever, in particular in an element of the control lever that scans a motion link.

10. The operating device according to claim 8, wherein the operating device has a motion link into which a control lever is guided, wherein the reset unit resets the motion link.

11. The operating device according to claim 8, wherein the motion link consists of multiple parts, wherein at least one of these motion link parts is reset by a reset unit.

12. The operating device according to claim 8, wherein the operating device has a contact surface contacted by a user, which is reset by the reset unit.
